(19) United States
(12) Patent Application Publication
(10) Pub. No.: US 2006/0227703 A1
(43) Pub. Date: Oct. 12, 2006

(54) Operating method for dynamic physical network layer monitoring

(76) Inventors: Wen-Chi Hung, Taipei Hsien (TW); Cho-Hsine Liao, Taipei Hsien (TW); An-Sheng Chang, Taipei Hsien (TW); Ju-Yi Hung, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/101,536

(22) Filed: Apr. 8, 2005

(51) Int. Cl. H04L 12/26; G06F 11/00

(52) U.S. Cl. 370/217; 370/252; 370/463; 719/321

(57) ABSTRACT

An operating method is disclosed for dynamic physical network layer monitoring. A plurality of built-in or extended network interface cards in a computer are to be merged or separated for multitasking operation, redundancy or any emergent application through continuously monitoring the network status. The network devices connected with the computer are checked after switching the computer on in the first step. Next, the drivers thereof are loaded to activate and initialize the network devices, and the connection therebetween is established. Afterward, the method further includes determining whether the devices need to be re-activated by continuously monitoring the network status.

### BACKGROUND OF THE INVENTION

1. Field of the Invention

The present invention relates to an operating method for dynamic physical network layer monitoring, more particularly, the plurality of physical network devices operate to be merged, separated, multitasking, redundancy or other emergent applications.

2. Description of Related Art

Since a variety of applications are developed in the Internet, a network interface card (NIC), such as RJ-45 LAN card, wireless module, becomes a standard equipment in a personal computer.

Further, two LAN cards disposed in one computer has another application for a number of network requirements. Wherein the application with numerous LAN cards, such as kinds of network servers like bridging server, gateway host or hub device, are required to achieve these specific functions. Particularly, those LAN cards can be merged to increase the substantial bandwidth, or implement load balance purpose, etc.

The concept of load balance can refer to the disclosure of U.S. Pat. No. 6,590,861, which described a method to send and receive data packets over a network of computer systems using a server computer system adapted to have a plurality of network interface cards (NICs) coupled thereto. An outgoing data packet is addressed using a first media access control (MAC) address, wherein the first MAC address is a virtual MAC address representing the plurality of NICs. Wherein a NIC is selected from the plurality of NICs using a load balancing scheme, and the functionality of the selected NIC is verified using a fault tolerance scheme.

The illustrated server computer system 10 of the prior art is shown in FIG. 1, which includes an application layer 101 of the ISO/OSI reference model, in which a network-related software, such as a web browser or a virtual conference software, is proceeded. The application layer 101 is coupled with a network layer 102, and the protocols used by the network layer 102 include, for example, TCP/IP (Internet Protocol), IPX (Internetwork Packet Exchange), or other protocols known in the art. Network layer 320 is responsible for determining addresses or for exchanging packets exchange between computers or between the computer and the network.

The server computer system 10 utilizes a dynamic access software element 103 to couple with the network layer 102 and a physical layer, such as the network interface card driver 12a, 12b, 12c, 12d of the network interface card 14a, 14b, 14c, 14d. The dynamic access software element 103 is used to control the network interface card drivers 14a, 14b, 14c, 14d being merged and function the load balance scheme based on the virtual local are network (VLAN) technique. Furthermore, the fault tolerance scheme is used to determine whether the selected NIC is functioning, and to automatically substitute one of the other NICs in case the selected NIC is not functioning.

U.S. Publication No. 2003/0063594 describes a load balance device and method for packet switching. Wherein the transmitting data is divided into a plurality of packets according to the transmission protocol. In the transmission process, a load monitor for each transmission port will decide which is outgoing port, thus the load balance is optimized.

In the prior art, several NICs are merged to reach load balance scheme, and to increase the download/upload bandwidth simultaneously, or even to achieve fault tolerance scheme in case of emergency. Nevertheless, the present invention further discloses that the merged NICs can be restored to individual physical NIC as emergent event occurs, but not affect the previous connection. In conclusion, the present introduces an operating method for dynamic physical network layer monitoring for achieving the functionality of redundancy by driving the related software or firmware, and implementing multitasking operation using individual NIC capable of multiple access.

### SUMMARY OF THE DISCLOSURE

Broadly speaking, an operating method for dynamic physical network layer monitoring is disclosed. Particularly, a plurality of built-in or extended network interface cards (at least two cards) are installed in a computer system. Wherein a driving program capable of redundancy monitors the network status and related network facilities constantly. The disclosed operating method employs the plurality of network interface cards being merged for load balance scheme or redundancy for emergent application, or multitasking operation.

The method comprises steps of switching a computer on in the beginning, then the network devices of the computer are detected and loading a driver of the network devices afterward, so as to activate the network devices and establish a connection. During the transmission or reception the network devices and the connection status are monitored, and determining whether the network drivers need to be re-activated and finally transmitting and receiving data.

### BRIEF DESCRIPTION OF DRAWINGS

The present invention will be readily understood by the following detailed description in conjunction accompanying drawings, in which:

FIG. 1 is a block diagram of a server network system of the prior art;

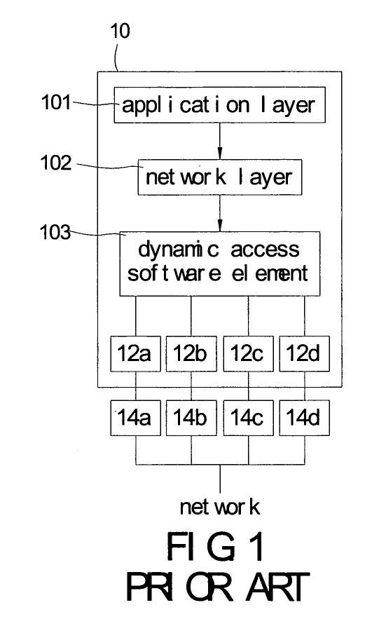

FIG. 2 is a block diagram of the first embodiment of the present invention;

FIG. 3 is a block diagram of the second embodiment of the present invention;

FIG. 4 is a block diagram of the third embodiment of the present invention; and

FIG. 5 is a flow chart of the operating method for dynamic physical network layer monitoring of the present invention.

### DETAILED DESCRIPTION OF THE PREFERRED EMBODIMENTS

To allow the Examiner to understand the technology, means and functions adopted in the present invention further, reference is made to the following detailed description and attached drawings. The Examiner shall readily understand the invention deeply and concretely from the purpose, characteristics and specification of the present invention. Nevertheless, the present invention is not limited to the attached drawings and embodiments in following description.

In order to increase the bandwidth with load balance, or to achieve redundancy functionality, or to be multitasking operation, a plurality of built-in or extended network interface cards (NICs) are installed on the motherboard of a computer system of the present invention introducing an operating method for dynamic physical network layer monitoring. By activating the physical network devices therein, the capability of network devices monitoring and fault tolerance are achieved. Following description and figures are described as the preferred embodiments of the present invention.

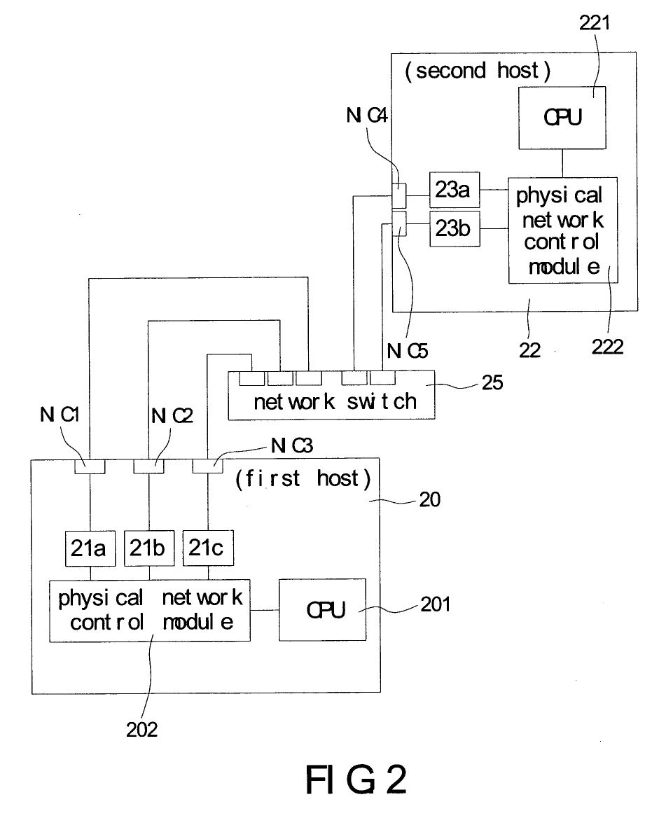

FIG. 2 shows the first embodiment of the present invention. Two computer hosts including a first host 20 and a second host 22 are connected with each other by installing a plurality of network interface cards in order to raise the transmission rate therebetween. The first host 20 can be a computer system such as a desktop computer, notebook, personal digital assistant (PDA). Wherein a central processing unit (CPU) 201 is included, so as to process the transmitting data and an input/output system control. The CPU 201 couples with a physical network control module 202, so as to control the data receiving and transmitting process of the physical network layer having the NIC drivers 21a, 21b, 21c coupled with the physical network control module 202. In the preferred embodiment, the NIC drivers 21a, 21b, 21c of the network interface cards NIC1, NIC2, and NIC3 are merged to integrate the data processing capability, and then to achieve load balance scheme, redundancy, and multitasking operation

Aforementioned physical network control module 202 is a driver, which is implemented with software or the firmware installed in the computer system. The physical network control module 202 is loaded in the computer system as booting the system, so as to activate the physical network devices. The network interface cards NIC1, NIC2, NIC3 coupled with the NIC drivers 21a, 21b, 21c are separately linked in a wired or wirelessly manner with a network switch 25. In a preferred embodiment, the network interface cards NIC1, NIC2, and NIC3 can be a virtual local area network (VLAN).

The host 22 includes a CPU 221 coupled with a physical network control module 222, and the physical network control module 22 couples with a plurality of NIC drivers 23a, 23b, so as to control the network interface cards (NICs) NIC4 and NIC5. In a preferred embodiment, the network interface cards NIC4 and NIC5 link in a wired or wirelessly manner with the network switch 25, and form another virtual local area network (VLAN).

As mentioned above, the virtual local area network formed by the plurality of NICs of the first host 20 links to the virtual local area network formed by the plurality of NICs of the second host 22 through the network switch 25. Moreover, each virtual local area network has an individual virtual IP address, which is provided for the connection. Then the plurality of NICs bound to the two VLANs are used to transmit the files with load balance functionality. For example, the files-to-be-transmitted in first host 20 are divided into a plurality of small packets by the operation of CPU 201 thereof, and being transmitted via the individual NIC (NIC1, NIC2, NIC3). Next, as the small packets are received by the second host 22, the packets will be merged into the original files through the operation of CPU 221 of the host 22. The load balance scheme is implemented as an increase in transmission/reception rate between the first host 20 and the second host 22.

During the transmitting or receiving process, the physical network control module 222 within monitors the transmitting/receiving packets and the status of the physical network devices. If one of the NICs fails, the physical network control module 222 will actively deactivate the NIC and guarantee the transmission/reception processes continuously.

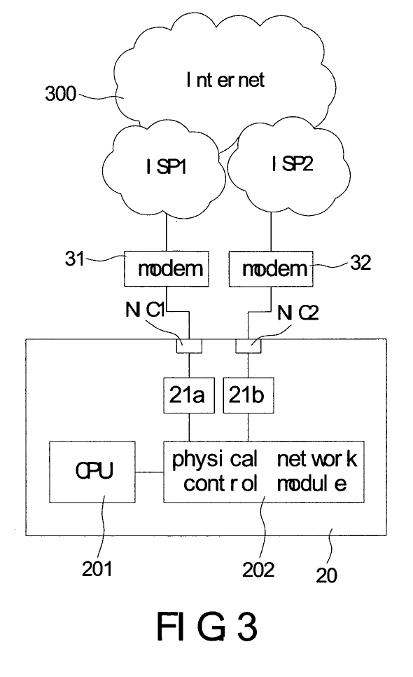

FIG. 3 shows the third embodiment of the present invention. The CPU 201 installed in the host 20 processes the transmitting operation, the CPU 201 further couples with the physical network control module 202, which is implemented as software or firmware. Whereby the plurality of NIC drivers 21a, 21b coupling with network interface cards NIC1 and NIC2 are activated and under monitoring. In the preferred embodiment, the host 20 having the network interface cards NIC1, NIC2 connects with the two modems 31, 32 (or routers) respectively, and accesses Internet 300 through the Internet service providers ISP1, ISP2 by dial-up or fixed-IP connection (dedicated line or ADSL) method.

Since the network interface cards NIC1 and NIC2 are allotted or being configured a plurality of IP addresses from the different Internet service providers (ISP1, ISP2), the NIC drivers 21a, 21b of the NICs are activated by the physical network control module 202, and linking the Internet simultaneously. In the meantime, the physical network control module 202 can find an optimized connecting path as monitoring the connection and bandwidth usage. If one of the connections through the different ISPs fails, the transmitting/receiving flow will be changed to another connection automatically for implementing redundancy.

A general on-line game identifies the player's ID by the connecting IP address, and provides a connection session for each IP address, namely one IP address only provides one account logging in the on-line game or other services. Nevertheless, one computer host of the present invention owns a plurality of IP addresses since a plurality of NICs are activated to establish many connections through different ISPs. After that, multiple sessions are established between the game server and the computer host.

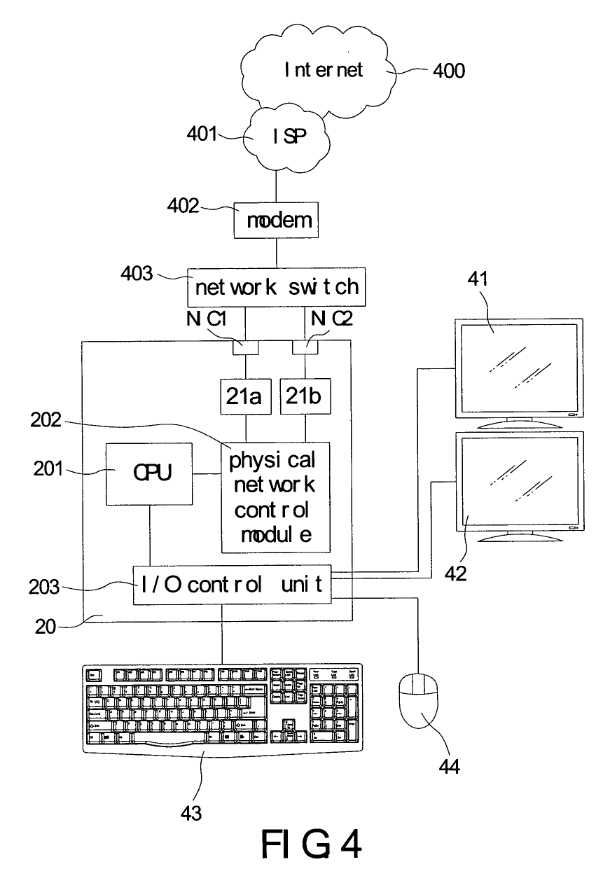

Reference is made to FIG. 4 showing a block diagram of the invention. The host 20 includes the CPU 201 coupling with the physical network control module 202, which is implemented as software or the firmware installed in the IC of the motherboard of the computer system. The physical network control module 202 activates and monitors the NIC drivers 21a, 21b of the network interface cards NIC1, NIC2. Wherein the network interface cards NIC1 and NIC2 connect in the wired and wirelessly manner with the network switch or a hub 403, and simultaneously establish a plurality of connections to Internet 400 through the ISP 401 by dial-up connection through modem 402 or fixed-IP connection through ADSL or a dedicated line. The CPU 201 of the host 20 couples with an input/output control unit 203, for example, the I/O control unit 203, such as the south bridge chip of the motherboard is used to control the peripheral devices, couples with a keyboard 403, mouse 44 and a plurality of monitors like first monitor 41 and second monitor 42. Since the plurality of NICs of the host 20 have a plurality of network addresses, the user can monitor a plurality of games by the plurality of monitors. The user can perform different games or different accounts for one game at the same time by switching the input/output peripheral devices.

The present invention adopts the plurality of built-in or extended NICs with the method for dynamic physical network layer monitoring. The physical network control module within the computer system is used to monitor the NICs and the available transmitting/receiving rate after booting the system. The physical network control module can merge the plurality of NICs into one physical network for achieving load balance scheme. If one of the NICs fails, the connection will not be affected by dynamically adjusting the transmitting/receiving rate for each NIC. Furthermore, the plurality of NICs can be performed as multitasking operation or redundancy.

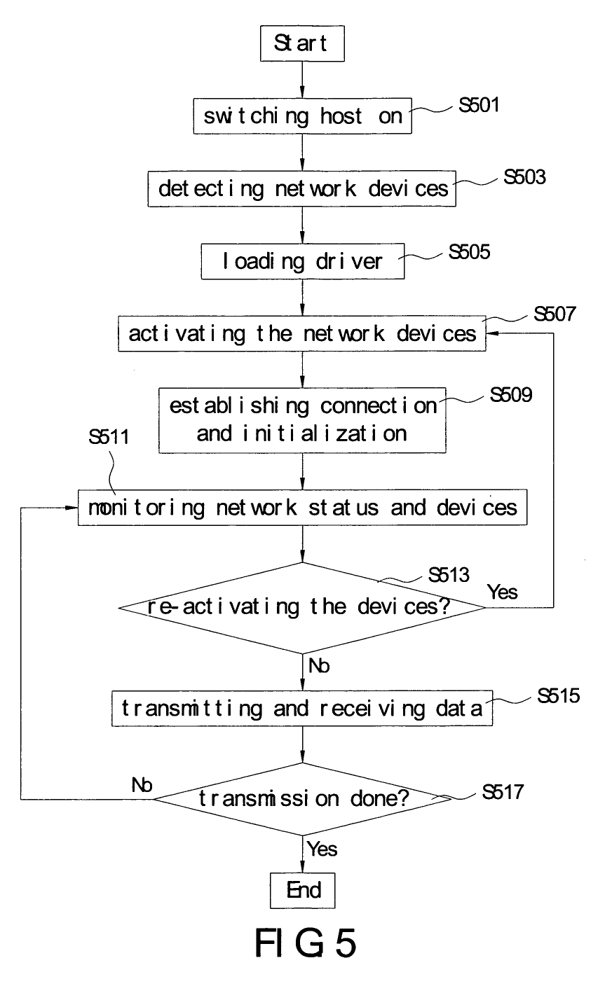

FIG. 5 shows the flow chart of operating method for dynamic physical network monitoring of the present invention.

To begin, the computer host is switched on in the step S501, then the computer system detects the network devices such as the built-in or extended network interface cards (NIC) and the driving chips thereto (step S503). After that, the operating system of the computer is entered, and manually or automatically loading the driver of the physical network devices (step S505). The physical network control module disclosed in the present invention is implemented as software or the firmware to activate to network devices and load the configuration program thereof (step S507).

After establishing the connection to the server provided by the Internet service providers by dial-up or fixed-IP allotment, the connection is initialized including one or a plurality of allotted IP addresses, domain name service (DNS), gateway host configuration or other related settings (step S509). After the aforementioned steps, the driving program of the physical network control module operates as a background monitoring process, such as flow monitoring, network device's status, network loading for each transmission port, multitasking usage, and redundancy status (step S511). As emergency occurs, step S513 is to determine whether the network drivers need to be re-activated, the conditions thereof includes:

(1) determining whether the plurality of NICs are merged for achieving load balance scheme;

(2) determining whether the plurality of NICs activates individually;

(3) determining whether the plurality of NICs operates as multitasking operation with multiple access; and

(4) determining whether the plurality of NICs operates as redundancy.

The step of determining whether the network driver needs to be re-activated operates as a background monitoring process (step S513). If one of the NICs in charge of load balance functionality fails, the physical network control module can determine to re-activate the network driver instantly, and operate the step S507 to activate to network devices again. Then the physical network control module monitors the network status and adjusts the transmitting/receiving rate, afterwards, the load balance mode is changed without any influence on original transmission. When the network devices and status are in regular operation after aforementioned adjusting, step S515 is processed.

Through the instant monitoring mentioned above, the plurality of NICs can be merged into one physical network for achieving load balance scheme, and can operate individually. After that, to determine whether the transmission is done? (step S517), if the transmission is done, end the process of the present operating method, if the transmission is not yet done, the monitoring and operating steps of the step S511 to step S517 are processed continuously.

The operating method for dynamic physical network layer monitoring is disclosed. The plurality of built-in or extended network interface cards in the computer system are introduced to implement the load balance scheme by merging the NICs, and the functionality of redundancy by driving the related software or firmware, and also the multitasking operation using individual NIC capable of multiple access.

The many features and advantages of the present invention are apparent from the written description above and it is intended by the appended claims to cover all. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. An operating method for dynamic physical network layer monitoring, comprises:
switching a computer on, wherein the computer includes a plurality of physical network devices;
detecting the network devices of the computer;
loading a driver of the network devices;
activating the network devices;
establishing a connection;
monitoring the network devices and the connection status;
determining whether the network drivers need to be re-activated; and
transmitting and receiving data.

2. The operating method as recited in claim 1, wherein the plurality of physical network devices include built-in or extended network interface cards.

3. The operating method as recited in claim 1, wherein the step of determining whether the network drivers need to be re-activated is operated as a background monitoring process.

4. The operating method as recited in claim 1, wherein the step of determining whether the network drivers need to be re-activated includes a step of determining whether the physical network devices are merged to achieve load balance scheme.

5. The operating method as recited in claim 1, wherein the step of determining whether the network drivers need to be re-activated includes a step of determining whether the plurality of physical network devices operate individually.

6. The operating method as recited in claim 1, wherein the physical network devices operate as multitasking operation with multiple access.

7. The operating method as recited in claim 1, wherein the physical network devices operate as monitoring the physical network layer for redundancy.

8. The operating method as recited in claim 1, wherein the physical network devices establish a plurality of connections by connecting to a plurality of Internet service providers.

9. The operating method as recited in claim 1, wherein the connection is established by dialing or fixed-IP connection.

10. The operating method as recited in claim 1, wherein the drivers is activated as firmware or software.
